(19) United States
(12) Patent Application Publication
(10) Pub. No.: US 2014/0007506 A1
(43) Pub. Date: Jan. 9, 2014

(54) BARRIER MEANS AND METHOD OF USE THEREOF

(71) Applicant: Team Excel Development Ltd., Shanghai (CN)

(72) Inventor: Tyler Huang, Shanghai (CN)

(21) Appl. No.: 13/934,672

(22) Filed: Jul. 3, 2013

(30) Foreign Application Priority Data
Jul. 4, 2012 (GB) 1211891.5

(51) Int. Cl. E06B 3/32; E06B 3/36

(52) U.S. Cl. CPC E06B 3/32; E06B 3/36
USPC 49/149; 49/381; 49/506; 49/394

(57) ABSTRACT

A barrier means suitable for use as a child safety gate, said barrier means including hinge means to allow the barrier means to be hingedly moved between a first closed position, wherein access past the barrier means is substantially prevented, and a second open position, wherein access past the barrier means is possible. User actuation means are provided on or associated with said hinge means, and actuation of said user actuation means allows said hinge means to be moved from a first engaged position to a second disengaged position.

This invention relates to barrier means and to a method of use thereof.

Although the following description refers almost exclusively to barrier means in the form of an extendable child safety gate, it will be appreciated by persons skilled in the art that the barrier means of the present invention could be any barrier means, such as a gate, guard and/or the like used for any purpose. The barrier means of the present invention could be extendable or non-extendable.

According to a first aspect of the present invention there is provided barrier means, said barrier means including hinge means to allow the barrier means to be hingedly moved between a first closed position, wherein access past the barrier means is substantially prevented, and a second open position, wherein access past the barrier means is possible, characterised in that user actuation means are provided on or associated with said hinge means, and actuation of said user actuation means allows said hinge means to be moved from a first engaged position to a second disengaged position.

Thus, the hinge arrangement of the barrier means is provided with a user actuated release mechanism that allows a user to quickly and easily release the hinge from an engaged position, thereby allowing easy removal of the barrier means from a hinged position, without the use of any special tools or skill.

In one embodiment the hinge means includes a housing and at least one hinge pin.

Preferably the at least one hinge pin is pivotably or hingedly mounted in a recess, aperture or channel within the housing. The hinge pin can pivot or hingedly move relative to the housing in use to allow the barrier means to be moved between the open and closed positions.

Preferably engagement means are associated with the hinge means and said engagement means retain the hinge means in the first engaged position in use.

Preferably the engagement means are resiliently biased to the first engaged position. A user typically has to overcome the resilient bias of the engagement means by actuating the user actuation means to move the engagement means from the first engaged position to the second disengaged position.

In one embodiment the engagement means can include any or any combination of one or more clips, sprung clips, inter-engaging members, protrusions and/or the like.

In a preferred embodiment the engagement means is a sprung clip.

Preferably the sprung clip has at least one protruding arm, said arm engaging with at least a part of the hinge housing to retain the hinge pin in the first engaged position in use.

Preferably actuation of the user actuation means releases said at least one protruding arm from engagement with the housing and/or moves the protruding arm in such a manner to allow removal of the hinge pin from the hinge housing and/or engagement with the sprung clip.

Preferably the sprung clip is substantially U-shaped in form. A protruding spring arm is preferably provided on each side of the U-shaped clip.

The sprung clip typically sits around a part of the hinge pin in use. Preferably the hinge pin has a tapered or narrow section and the engagement means or sprung clip is retained in place by the tapered or narrow section.

Preferably the user actuation means is in the form of a button, lever and/or the like. A user is typically required to depress the button, lever and/or the like to actuate the same in use. For example, in one embodiment a user is required to depress or move the user actuation means in a direction towards the housing of the hinge means to actuate the engagement means and/or sprung clip and move the engagement means and/or sprung clip from the first engagement position to the second engagement positions.

In one embodiment the user actuation means are slidably mounted in the hinge housing. Actuation of the user actuation slidably moves the user actuation means which in turn moves the engagement means and/or sprung clip from the first engaged position to the second disengaged position.

At least part of the engagement means or the sprung clip is attached to the user actuation means to allow movement of the sprung clip or engagement means on movement of the user actuation means.

Marker means can be provided on or associated with the user actuation means to visually inform the user on which way the user is required to move the user actuation means and/or hinge means to allow the hinge means to be moved from the first engaged position to the second disengaged position.

Once the hinge means has been moved to a disengaged position, a user is typically able to lift or remove the hinge pin from the hinge housing.

The barrier means can include one or more hinge means. Preferably the barrier means includes two or more hinge means. In a preferred embodiment the barrier means includes at least a first upper hinge means and a second lower hinge means.

Two or more hinge means can include the hinge arrangement as described above.

In one embodiment the barrier means includes a further hinge means, said further hinge means includes a hinge pin and a hinge housing. Preferably the hinge pin is detachably attached to a recess, aperture or channel defined in the hinge housing, and further preferably detachment of the hinge pin from the recess, aperture or channel is achieved simply by lifting the hinge pin from the recess, aperture or channel.

In one embodiment the barrier means includes a hinge means including user actuation means as described above and a further hinge means that has no user actuation means associated therewith.

Preferably the hinge housing of the hinge means or further hinge means is provided with or has attachment means associated therewith for allowing attachment of the hinge housing directly or indirectly to a suitable surface in use. For example, the attachment means can include one or more apertures, screws, adhesive, welding, nuts and bolts, inter-engaging members and/or the like.

In one embodiment the hinge pin has a first end that is located in the recess, aperture or channel of the hinge housing in use and a second end.

Preferably the tapered or narrower portion of the hinge pin is provided at or adjacent the first end. One or more shoulder portions are typically defined between the tapered or narrower portion and the remainder portions of the hinge pin. The one or more shoulder portions retain the engagement means or sprung clip in position on the hinge pin in use.

In one embodiment of the present invention the barrier means includes direction restriction means to restrict or define the direction in which the barrier means can be moved between the open and closed positions in use.

Preferably said direction restriction means includes a housing having location means for locating at least part of the barrier means, directly or indirectly, therewith in use.

Preferably the location means includes an aperture, recess, channel and/or the like. An end of the barrier means, frame member or joining means associated with an end of the barrier means or frame member can be located in an opening of said aperture, recess, channel and/or the like when the barrier means is in the closed position in use, thereby supporting the same.

Preferably the opening of said aperture, recess, channel and/or the like is defined in a front portion and a side portion of the housing, thereby allowing a part of the barrier means, frame member or joining means to be placed through the opening and to protrude therefrom when the barrier means is in the closed position.

Preferably one or more restrictor elements are attachable to or detachably attachable to the housing at or adjacent the opening of said aperture, recess, channel and/or the like to restrict movement and/or restrict the orientation from which the part of the barrier means, frame member or joining means locatable in the opening can be removed therefrom in use. This defines the direction the barrier means can be moved in use.

Preferably one or more restrictor elements are attachable or detachably attachable to two or more possible positions or can be arranged in two or more different orientations to allow two or more different restriction positions to be provided via which the barrier means, frame member or joining means can be removed from the location means in use.

In one embodiment the restrictor elements are attached or detachably attached via one or more apertures or recesses defined in the housing. Two or more apertures or recesses can be defined in the housing to provide the two or more possible positions. The user can select which aperture or recess the position of the restrictor element is to be placed in use, thereby allowing the user to select which direction the barrier means can be opened in use.

Preferably the direction restrictor housing includes attachment means for attaching the housing to a surface between which the barrier means is to be located in use. For example, the attachment means can include one or more apertures, screws, adhesive, welding, nuts and bolts, inter-engaging members and/or the like.

In one embodiment one or more parts of the direction restrictor housing defining the opening of the location means can be provided with ramp means, a sloping or angled surface and/or the like to allow ease of location of part of the barrier means, frame member, joining means with the location means in use.

Preferably the direction restrictor means are provided on a side of the barrier means that is moved between the open and closed positions in use and/or is substantially opposite to the side of the barrier means with the hinge means.

The direction restrictor means can be provided on or associated with an upper and/or lower section or frame of the barrier means.

In one embodiment the barrier means include lock or release means for allowing the barrier means to be moved between locked and unlocked positions in use. With the barrier means in the locked position, the barrier means cannot be moved from the closed position to the open position. With the barrier means in the unlocked position, the barrier means can be moved from the closed position to the open position.

Preferably the lock or release means includes a housing with location means defined in said housing for location of at least part of the barrier means, frame member, joining means and/or the like therewith in use.

The location means can be an aperture, recess, channel and/or the like.

Preferably an opening is defined in said location means to allow said at least part of the barrier means, frame member, joining means and/or the like to be located in and/or removed from said location means in use.

In one embodiment resilient biasing means are provided in or associated with the location means for resiliently biasing the barrier means, frame member, joining means and/or the like in a direction out of the opening in use.

In one embodiment a locking member is movably mounted on said housing for moving the same with respect to the opening of the location means between the locked and unlocked positions. In the locked position, the locking member is provided over said opening and/or substantially blocks said opening to prevent removal of the barrier means, frame member, joining means and/or the like therefrom in use. In the unlocked position, the locking member is moved clear of said opening to allow removal of the barrier means, frame member, joining means and/or the like therefrom in use.

The locking member can be rotatably, slidably or pivotably mounted to said housing to allow the locking member to be rotated, slid or pivoted between the locked and unlocked positions.

In one embodiment the locking member is in the form of a handle and/or a gripping portion is provided on the locking member and/or handle to allow a user to grip the handle or locking member and move the same between the locked and unlocked positions.

Preferably the lock or release means are provided on a side of the barrier means that is moved between the open and closed positions in use and/or is substantially opposite to the side of the barrier means with the hinge means.

The lock or release means can be provided on or associated with an upper and/or lower section or frame of the barrier means.

In one embodiment the barrier means is an extendable gate including two or more gate panels. One end of each of the first and at least second gate panels is typically attachable to or detachably attachable directly or indirectly to a surface between which the barrier means is to be located in use. An opposite end of each gate panel is typically arranged to at least partially overlap with the opposite end of the other gate panel. Connection means are provided to allow connection between the overlapping ends of the gate panels.

Preferably the connection means include a first connection member and at least a second connection member detachably attached or attached to said first connection member via attachment means. The degree or distance of overlap between the gate panels can be determined according to the size or width of the opening in which the barrier means is to be located in use. The connection means can then be connected to the gate panels to secure the gate panels at the selected width.

The attachment means can include any or any combination of one or more clips, resilient clips, screws, nuts and bolts, friction fit, welding, adhesive, inter-engaging members, protrusion/recess fit and/or the like.

Preferably the first connection member engages directly or indirectly with a transverse or horizontal frame member of a first gate panel and with an upright frame member of said first gate panel. The second connection member engages with the first connection member and engages with an upright frame member of said second gate panel.

Further preferably the first connection member engages directly or indirectly with a transverse or horizontal frame member of a first gate panel via first engagement means and with an upright frame member of said first gate panel via second engagement means. The second connection member engages with the first connection member via the attachment means and engages with an upright frame member of said second gate panel via third engagement means.

The first engagement means, second engagement means and/or third engagement means can include any or any combination of one or more clips, resilient clips, tapered interference fit, screws, nuts and bolts, friction fit, welding, adhesive, inter-engaging members, protrusion/recess fit and/or the like.

In one embodiment a free end of the transverse or horizontal frame member is provided with a frame insert or bung to locate in an opening at said free end. Preferably the first connection member engages with said frame insert or bung in use.

In an alternative embodiment the frame insert or bung is attached to or forms an integral part of the first connection member.

In one embodiment the first engagement means includes a tapered interference fit.

Preferably two connection means are provided on or associated with an upper frame member of the barrier means and/or two connection means are provided on or associated with a lower frame member of the barrier means (i.e. one connection means is provided on each overlapping end of the gate panel).

According to a second aspect of the present invention there is provided a method of using barrier means.

According to further independent aspects of the present invention there is provided barrier means having direction restriction means; barrier means having connection means; barrier means having release means; and a method of using any of said barrier means.

According to yet further independent aspects of the present invention there is provided hinge means; direction restriction means; connection means; release means; and a method of using any of said means.

The barrier means can be in the form of a gate, child safety gate, window, guard, any barrier that allows selective access from one locality to another locality and/or the like.

The barrier means can be extendible or non-extendible as required.

It will be appreciated that any or any combination of the abovementioned features can be provided on barrier means according to the present invention.

Embodiments of the present invention will now be described with reference to the accompanying figures, wherein:

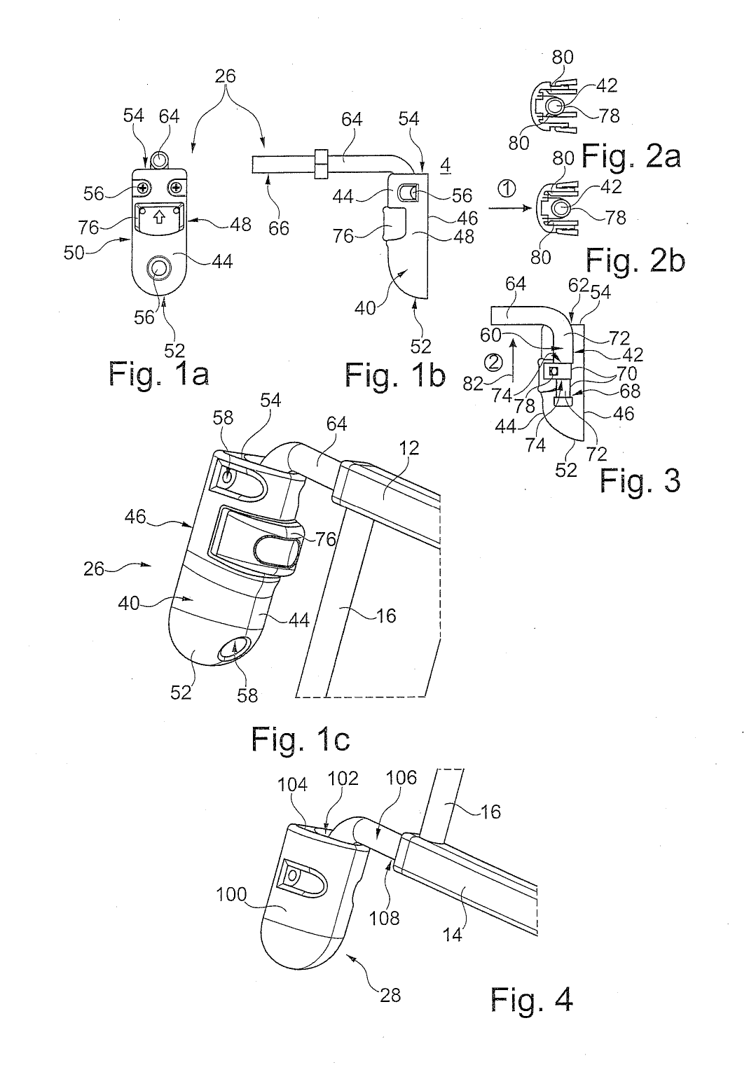

FIGS. 1a-1c show hinge means of the barrier means according to an embodiment of the present invention from a front view, side view and perspective view respectively;

FIGS. 2a and 2b show a plan view of the hinge means in an engaged position and a disengaged position respectively;

FIG. 3 shows an internal view of the hinge means in an engaged position;

FIG. 4 shows a view of further hinge means according to a further embodiment of the present invention

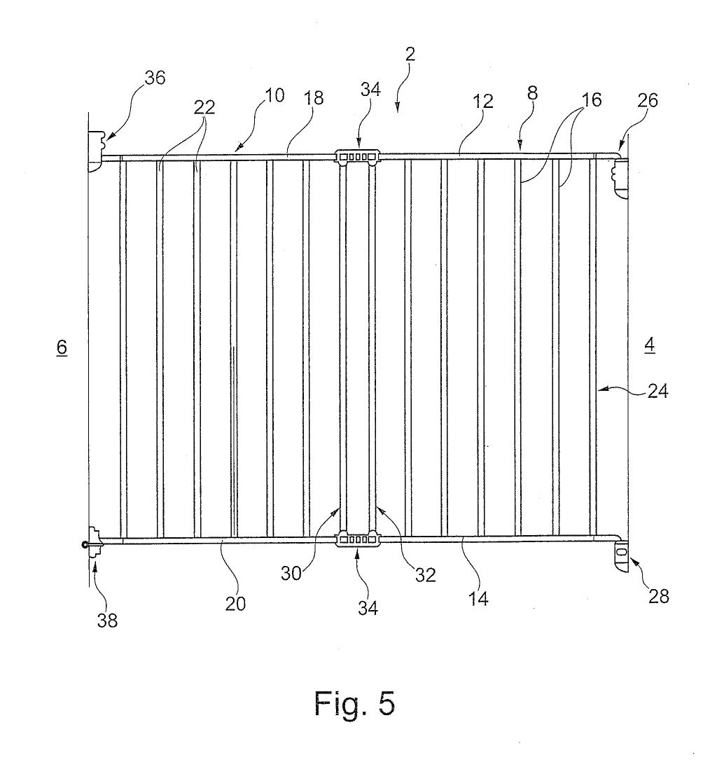

FIG. 5 shows a front view of barrier means according to an embodiment of the present invention;

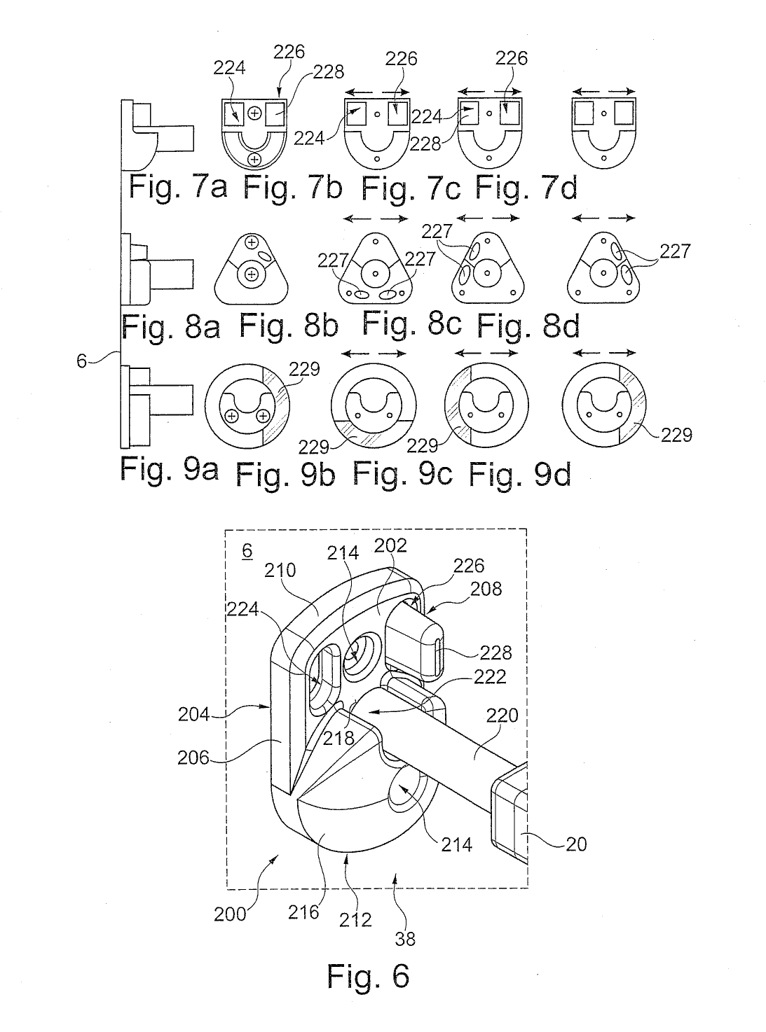

FIG. 6 shows a perspective view of direction restriction means according to an embodiment of the present invention;

FIGS. 7a-7d show a side view, a front view with restricted access to the right hand side, a front view with no restricted access, a front view with restricted access to the left hand side using direction restriction means according to a first embodiment of the present invention respectively;

FIGS. 8a-8d show a side view, a front view with restricted access to the right hand side, a front view with no restricted access, a front view with restricted access to the left hand side using direction restriction means according to a second embodiment of the present invention respectively;

FIGS. 9a-9d show a side view, a front view with restricted access to the right hand side, a front view with no restricted access, a front view with restricted access to the left hand side using direction restriction means according to a third embodiment of the present invention respectively;

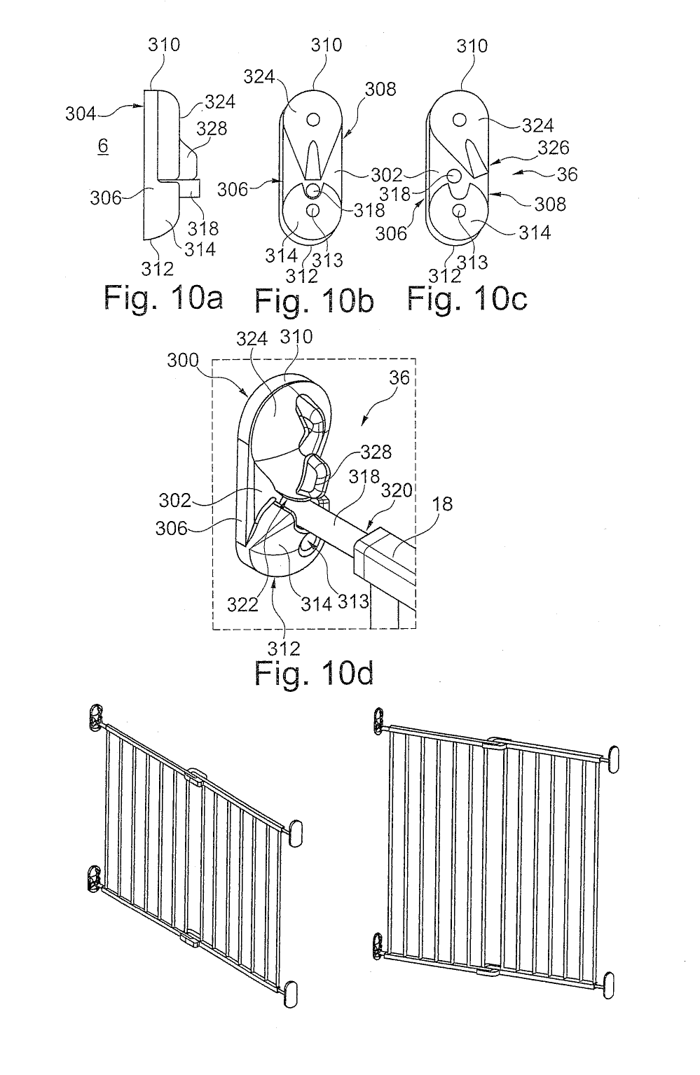

FIGS. 10a-10d show a side view, front view in a closed position, front view in an open position and perspective view in a closed position of gate release means according to an embodiment of the present invention respectively; and

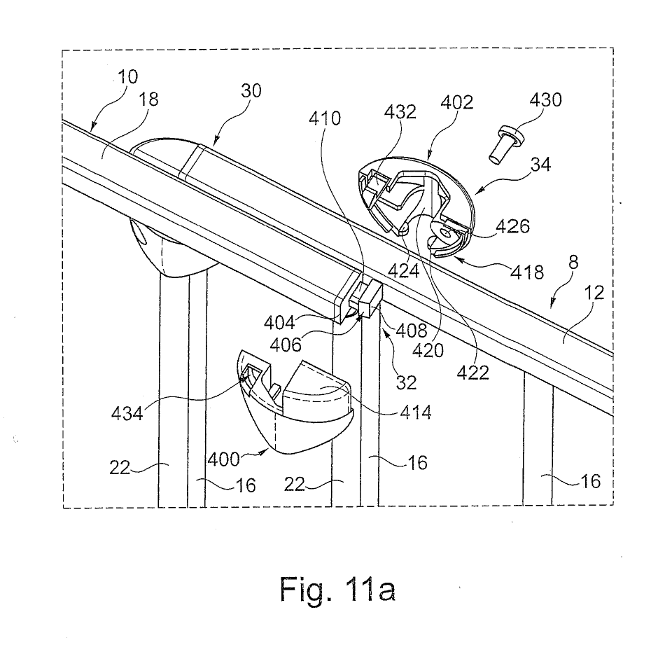

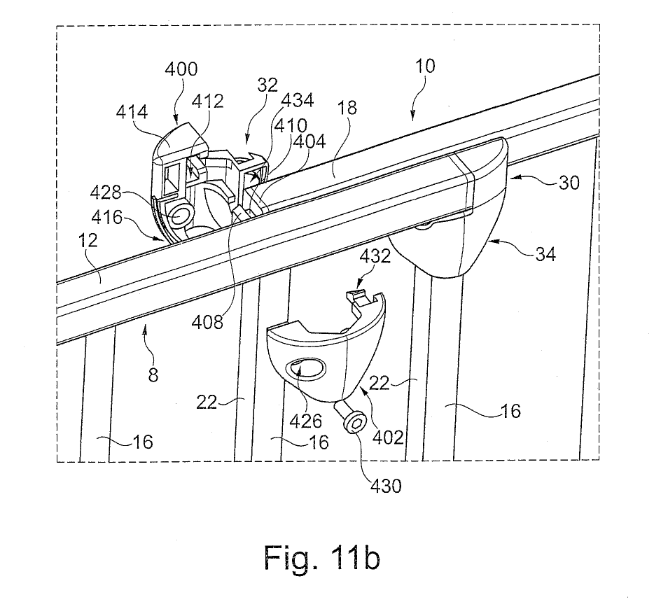

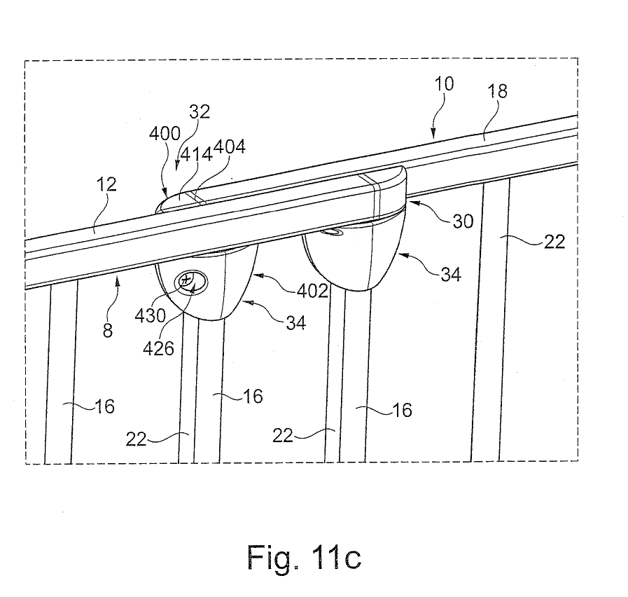

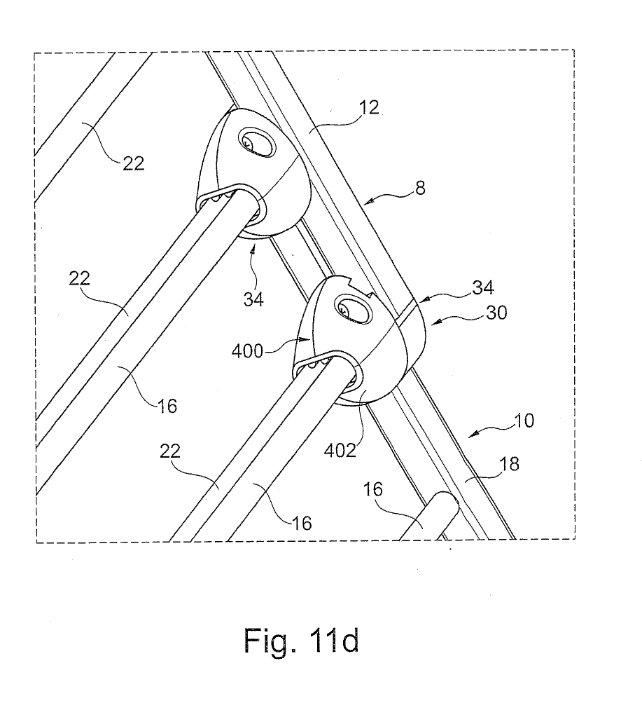

FIGS. 11a-11d show a perspective exploded view of connection means from a front of the gate, a perspective exploded view of connection means from a rear of the gate, a non-exploded perspective view of the connection from the rear of the gate, and a perspective view of the connection means in FIG. 11c from the base looking to the top respectively.

Referring firstly to FIG. 5, there is illustrated barrier means in the form of an extendable child safety gate 2. The gate 2 is for location in an opening defined between two surfaces 4, 6 for which selective access is required. Since the gate 2 is extendable, the width of the gate can be adjusted to fit a range of different sized openings. When fitted, the gate 2 can be hingedly moved between a first closed position, as shown in FIG. 5, wherein the gate is substantially perpendicular to one or more of the wall surfaces between which it is fitted and access through the opening is substantially prevented, to a second open position, wherein the gate is moved relative to one or more of the wall surfaces between which it is fitted and access through the opening is allowed.

The gate 2 includes a first gate panel 8 and a second gate panel 10. First gate panel 8 includes an upper frame member 12, a lower frame member 14 and a plurality of spaced apart upright frame members 16 located therebetween. Second gate panel 10 includes an upper frame member 18, a lower frame member 20 and a plurality of spaced apart upright frame members 22 located therebetween.

In the illustrated example, upper and lower frame members 12, 14, 18, 20 are arranged to be substantially horizontal. Upright frame members 16, 22 are arranged to be substantially vertical. The upright frame members 16, 22 are typically substantially perpendicular to the upper and lower frame members 12, 14, 18, 20.

End 24 of first gate panel 8 is hingedly mounted to surface 4 via a first hinge arrangement 26 associated with upper frame member 12 and a second hinge arrangement 28 associated with lower frame member 14. An opposite end 30 of first gate panel 8 is connected to end 32 of second gate panel 10 via a first pair of connection means 34 provided with the upper and lower frame members. The opposite end of gate panel 10 is detachably attached to surface 6 via release means 36 associated with upper frame member 18 and direction restrictor means 38 associated with lower frame member 20. The opposite end 32 of the second gate panel 10 is connected to end 30 of first gate panel 8 via a second pair of connection means 34 provided with the upper and lower frame members.

### First Hinge Arrangement

Referring to FIGS. 1a-3, there is illustrated a first hinge arrangement 26 according to an embodiment of the present invention. The hinge arrangement 26 provides a user actuated release mechanism to allow quick and easy release of the hinge and/or gate 2 from surface 4 in use.

Hinge arrangement 26 includes a hinge housing 40 and a hinge pin 42. The housing 40 has a front surface 44, a rear surface 46, side surfaces 48, 50, a base surface 52 and a top surface 54. The rear surface 46 of housing 40 is attached to wall surface 4 using a plurality of screws 56 located through apertures 58 defined in housing 40.

The hinge pin 42 includes a first pin part 60, which is located in a recess 62 defined in top surface 54, and a second pin part 64 which protrudes outwardly of housing 40 and is typically provided substantially perpendicular or transverse to first pin part 60. First pin part 60 is typically capable of free rotation within recess 62 when the gate 2 is moved from a closed position to an open position. An end 66 of second pin part 62 is located in a suitable shaped recess defined in upper frame member 12 in use, as shown in FIG. 1c. An end 68 of first pin part 60 has a narrower section 70 compared to the remainder section 72 of first pin part 60. Shoulder portions 74 are defined between the narrower section 70 and the wider remainder sections 72.

User actuation means in the form of a button 76 is provided on front surface 44 of hinge housing 40. The button 76 is slidably mounted to housing 40 to allow the button to be moved between depressed and protruding positions with respect to the housing.

Resilient biasing engagement means in the form of a sprung clip 78 is retained around the narrower section 70 of first hinge pin part 60 in use and is joined to a rear surface of button 76. The sprung clip 78 can be moved between an engaged position, wherein the clip engages the hinge pin portion 60 and removal of hinge pin portion 60 is prevented, and a disengaged position, wherein the clip disengages the hinge pin portion 60 and removal of the hinge pin part 60 is allowed.

Sprung clip 78 is substantially U-shaped in form and has a pair of outwardly protruding spring arms 80, each arm 80 provided on an opposite side of u-shaped clip 78. As a user depresses button 76 towards housing 40 (i.e. a user applies a force in a direction towards housing 40 or substantially perpendicular to front surface 44 and/or hinge pin part 60), this causes arms 80 to flex inwardly, thereby releasing engagement of the arms from housing 40 and moving the clip out of engagement with the hinge pin. The hinge pin part 60 can then simply be lifted out of recess 62 in housing 40 by a user, as shown by arrow 82 in FIG. 3.

### Second Hinge Arrangement

Referring to FIG. 4, there is illustrated a second hinge arrangement 28 that is associated with lower frame member 14 of gate panel 8. Hinge arrangement 28 includes a hinge housing 100 having a recess 102 defined in a top surface 104 thereof. The hinge housing 100 is joined to wall surface 4 in a similar manner to hinge housing 40 described above. A hinge pin 106 has a first end (not shown) located in recess 102 and a second end 108 attached to lower frame member 14. Hinge pin 106 is capable of free rotation in recess 102 on moving the gate 2 between closed and open positions. In order to remove hinge pin 106 from recess 102, the hinge pin 106 is simply moved in an upwardly direction or lifted. This removal can only typically take place once the first hinge arrangement is in a disengaged position.

### Direction Restrictor Means

Referring to FIG. 6, there is illustrated direction restriction means 38 for allowing a user to selectively restrict or choose the direction in which the gate 2 can be opened in use.

Direction restriction means 38 includes a housing 200 having a front surface 202, a rear surface 204, sides 206, 208, a top 210 and a base 212. Attachment means in the form of apertures 214 are defined through housing 200 to allow screws to be fitted therethrough for attachment of direction restrictor 38 to surface 6 in use.

Location means 216 are defined in front surface 202 and a recess 218 is defined as part of said location means 216 to allow location of part of the gate 2 therein in use, thereby supporting said part of the gate when the gate is in a closed position. More specifically, a joining bar 220 has a first end joined to lower frame member 20 and a second end 222 that is located through an opening of recess 218 in use when the gate 2 is in a closed position. The opening of recess 218 is provided both at a top and side of the recess to allow joining bar 220 to protrude outwardly therefrom when in a supported position, as shown in FIG. 6, in a direction substantially perpendicular to housing 200 and surface 6, and also to allow end 222 of joining bar 220 to be lowered into the opening from a direction from top 210 to base 212 of housing 200 to form the supported position, and to be raised from the opening to allow opening of the gate.

Apertures 224, 226 are defined in front surface 202 of housing 200 above the location means 216 and either side of the top of the recess 218. These apertures are for detachably receiving a restrictor element 228 therein in use. The restrictor element 228, when located in one of the apertures 224, 226 protrudes outwardly therefrom a distance sufficient to prevent or substantially block movement of joining bar 220 from the recess opening in the direction in which the restrictor element is located. Thus, with the restrictor element 228 located in the right hand side (RHS) aperture 226, joining bar 220 can only be released via the left hand side (LHS) of the housing 200, thereby ensuring the gate 2 can only be opened by moving the gate towards the LHS. A user selects which aperture 224, 226 the restrictor element 228 is to be located in use, thereby allowing the user to determine whether the gate is to be moved in a direction towards the LHS or RHS when opening the gate.

Referring to FIG. 7b, it can be seen that with restrictor element 228 located in RHS aperture 226, the gate can only be opened via the LHS. In FIG. 7c, it can be seen that no restrictor element is located in either aperture 224, 226 and therefore the gate can be opened in either direction via the LHS or the RHS. In FIG. 7d, it can be seen that restrictor element 228 is located in LHS aperture 224 and therefore the gate can only be opened via the RHS.

The housing 200 can be provided in any suitable shape, size and/or design. In FIGS. 7a-7d, the housing 200 is substantially U-shaped in form. In FIGS. 8a-8d, the housing is substantially triangular in shape. The restrictor elements 227 can be moved between different sides of the triangular housing to create different restriction positions. In FIGS. 9a-9d, the housing is substantially circular in shape. The restrictor element 229 can be moved between different sectors of the circle to create the different restriction positions.

### Gate Release Means

Referring to FIGS. 10a-10d, there is illustrated gate release means 36 according to an embodiment of the present invention. The gate release means allows the gate 2 to be moved between locked and unlocked positions. In the locked position, the gate 2 cannot be moved between open and closed positions. In the unlocked position, the gate 2 can be moved between open and closed positions.

The gate release means 36 includes a housing 300 having a front face 302, a rear face 304, sides 306, 308, a top 310 and a base 312. The housing 300 is attached to surface 6 via attachment means in the form of apertures 313 through which screws are provided. Location means 314 are defined on a lower part of front face 302. A recess 316 is defined in location means 314.

A joining member 318 has a first end 320 joined to an end of upper frame member 18 and a second end 322 that is located through an opening of recess 316 in use. With the gate 2 in a closed position, end 322 of joining member 318 sits in recess 316. With the gate in an open position, end 322 is moved clear of recess 316.

A locking member 324 is rotatably mounted on front face 302. A lower end 326 of locking member 326 is movable between a locked position, wherein the end 326 is located above the recess opening and substantially blocks the same, as shown in FIGS. 10b and 10d, and an unlocked position, wherein the end 326 is moves clear of the recess opening, as shown in FIG. 10c. With the locking member in the locked position, the end 322 of joining member 318 cannot be removed from recess 316 and the gate is retained in a closed position. With the locking member in the unlocked position, the end 322 of joining member 318 can be moved into and clear of recess 316 to allow the gate to be moved between open and closed positions.

A gripping portion 328 can be provided on locking member 326 to allow a user to easily grip and move the locking member between the locked and unlocked positions in use.

### Connector Means

Referring to FIGS. 11a-11d, there is illustrated connector means 34 for allowing the gate panels 8, 10 to be moved to different overlapping positions.

Each of the connector means 34 includes a first connection member 400 and a second connection member 402. In the illustrations of FIGS. 11a-1dd, single connector means 34 will be described in respect of connecting the end 32 of second gate panel 10 in overlapping relationship with the first gate panel 8 only for the purposes of clarity.

The gate panels 8, 10 are moved to a required width to fit the opening in which the gate is to be located in use, with the ends 30, 32 of the gate panels 8, 10 respectively overlapping by a required distance. An insert or bung 404 is located in the channel opening defined at the free end 32 of horizontal frame member 18 of gate panel 10. The bung 404 engages with first connection member 400 via first engagement means. The first engagement means includes an arm 406 protruding outwardly of bung 404 having a free end 408 and an intermediate part 410. The intermediate part 410 is tapered or has smaller dimensions than free end 408. A complementary shaped recess 412 defined in the interior of first connection member 400 slidably receives said intermediate part 410 and said free end 408 when assembled to form a friction fit or interference fit. First connection member 400 has a raised portion 414 adjacent a top of the connection member which forms a cover over the bung 404 and free end 32 of frame member 18 to provide an aesthetically pleasing finish.

A base of the first connection member 400 is provided with second engagement means for engaging with upright frame member 22 of gate panel 10 adjacent free end 32. The second engagement means is in the form of a resilient biased clip 416. Clip 416 is substantially U-shaped in form having a rear wall with two outwardly protruding clip arms protruding from said rear wall. The clip arms are resiliently biased inwardly towards each other (i.e. are biased towards an engaged position in use). The clip 416 is pushed into engagement with upright frame member 22 such that each of the outwardly protruding clip arms engage either side of upright frame member 22.

A base of second connection member 402 is provided with third engagement means in a similar form to the second engagement means of first connection member 400 to allow the second connection member 402 to engage with upright frame member 16 of gate panel 8. In particular, the third engagement means is in the form of a resilient biased clip 418. Clip 418 is substantially U-shaped in form having a rear wall 420 with two outwardly protruding clip arms 422, 424 protruding from said rear wall. The clip arms 422, 424 are resiliently biased inwardly towards each other (i.e. are biased towards an engaged position in use). The clip 418 is pushed into engagement with upright frame member 16 such that each of the outwardly protruding clip arms 422, 424 engage either side of upright frame member 16.

Second connection member 402 has attachment means for engaging with the first connection member 400 including an aperture 426 for location of a screw 430 therethrough which engages with a complementary aperture 428 defined in first connection member 400 on one side of the connection members 400, 402. The opposite side of the second connection member 402 has further attachment means in the form of a sprung clip 432 which locates in an aperture 434 defined in the first connection member.

In order to release the connection members 400, 402, the screw 430 is removed and the connection members are pulled apart.

1. A barrier means suitable for use as a child safety gate, said barrier means including hinge means to allow the barrier means to be hingedly moved between a first closed position, wherein access past the barrier means is substantially prevented, and a second open position, wherein access past the barrier means is possible, characterised in that user actuation means are provided on or associated with said hinge means, and actuation of said user actuation means allows said hinge means to be moved from a first engaged position to a second disengaged position.

2. A barrier means according to claim 1 characterised in that the hinge means includes a housing and at least one hinge pin.

3. A barrier means according to claim 2 characterised in that the at least one hinge pin is pivotably or hingedly mounted in a recess, aperture or channel within the housing and the hinge pin can pivot or hingedly move relative to the housing in use to allow the barrier means to be moved between the open and closed positions.

4. A barrier means according to claim 1 characterised in that engagement means are associated with the hinge means and said engagement means retain the hinge means in the first engaged position in use.

5. A barrier means according to claim 4 characterised in that the engagement means is a sprung clip resiliently biased to the first engaged position.

6. A barrier means according to claim 5 characterised in that the sprung clip has at least one protruding arm, said arm engaging with at least a part of the hinge housing to retain the hinge pin in the first engaged position in use.

7. A barrier means according to claim 6 characterised in that actuation of the user actuation means releases said at least one protruding arm from engagement with the housing and/or moves the protruding arm in such a manner to allow removal of the hinge pin from the hinge housing and/or engagement with the sprung clip.

8. A barrier means according to claim 7 characterised in that the sprung clip is substantially U-shaped in form and typically located around a part of the hinge pin in use.

9. A barrier means according to claim 8 characterised in that the hinge pin has a tapered or narrow section and the engagement means or sprung clip is retained in place by the tapered or narrow section.

10. A barrier means according to claim 1 characterised in that the user actuation means is in the form of a button, lever and/or the like and actuation of the same slidably moves the user actuation means which in turn moves the engagement means and/or sprung clip from the first engaged position to the second disengaged position.

11. A barrier means according to claim 10 characterised in that At least part of the engagement means or the sprung clip is attached to the user actuation means to allow movement of the sprung clip or engagement means on movement of the user actuation means.

12. A barrier means according to claim 1 characterised in that the barrier means includes direction restriction means to restrict or define the direction in which the barrier means can be moved between the open and closed positions in use, said direction restriction means including a housing having location means for locating at least part of the barrier means, directly or indirectly, therewith in use.

13. A barrier means according to claim 12 characterised in that one or more restrictor elements are attachable to or detachably attachable to the housing at, or adjacent to, the opening of said location means to restrict movement and/or restrict the orientation from which the part of the barrier means, frame member or joining means locatable in the opening can be removed therefrom in use.

14. A barrier means according to claim 1 characterised in that the barrier means includes lock or release means for allowing the barrier means to be moved between locked and unlocked positions in use wherein in the locked position, the barrier means cannot be moved from the closed position to the open position and with the barrier means in the unlocked position, the barrier means can be moved from the closed position to the open position.

15. A barrier means according to claim 14 characterised in that the lock or release means includes a housing with location means defined in said housing for location of at least part of the barrier means, frame member, joining means and/or the like therewith in use and the barrier means further includes a locking member movably mounted on said housing for moving the same with respect to the opening of the location means between the locked and unlocked positions, wherein in the locked position, the locking member is provided over said opening and/or substantially blocks said opening to prevent removal of the barrier means, frame member, joining means and/or the like therefrom in use and in the unlocked position, the locking member is moved clear of said opening to allow removal of the barrier means, frame member, joining means and/or the like therefrom in use.

16. A barrier means according to claim 1 characterised in that the barrier means is an extendable gate including two or more gate panels arranged to at least partially overlap, said barrier means including connection means to connect the overlapping ends of the gate panels, wherein said connection means includes a first connection member and at least a second connection member detachably attached or attached to said first connection member via attachment means.

17. A method of operating a barrier means according to claim 1, said method including the steps of actuating said user actuation means and moving at least one hinge means from a first engaged position to a second disengaged position.
